(19) United States
(12) Patent Application Publication
(10) Pub. No.: US 2019/0036762 A1
(43) Pub. Date: Jan. 31, 2019

(54) EXCEPTION MONITORING AND ALARMING METHOD AND APPARATUS

(71) Applicant: ALIBABA GROUP HOLDING LIMITED, George Town (KY)

(72) Inventor: Julei LI, Hangzhou (CN)

(73) Assignee: ALIBABA GROUP HOLDING LIMITED

(21) Appl. No.: 16/147,458

(22) Filed: Sep. 28, 2018

Related U.S. Application Data
(63) Continuation of application No. PCT/CN2017/077258, filed on Mar. 20, 2017.

(30) Foreign Application Priority Data
Mar. 29, 2016 (CN) 201610189079.6

(51) Int. Cl. H04L 12/24

(52) U.S. Cl. CPC H04L 41/0622

(57) ABSTRACT

An exception monitoring and alarming method and apparatus are provided. The method comprises: recording alarm information for a to-be-processed alarm item; determining whether the alarm information for the to-be-processed alarm item meets a fatigue condition; controlling the to-be-processed alarm item to enter a fatigue period when the alarm information for the to-be-processed alarm item meets the fatigue condition; and conducting alarm control on the to-be-processed alarm item in the fatigue period to reduce a number of alarms for the to-be-processed alarm item.

### CROSS REFERENCE TO RELATED APPLICATION

The present disclosure claims the benefits of priority to International Patent Application number PCT/CN2017/077258, filed Mar. 20, 2017, and Chinese Patent Application No. 201610189079.6, filed Mar. 29, 2016, both of which are incorporated herein by reference in their entireties.

### TECHNICAL FIELD

The embodiments of the present disclosure relate to communication technologies, and in particular, to an exception monitoring and alarming method and apparatus.

### BACKGROUND

Exceptions such as instability and errors are unavoidable in various application systems. When an exception occurs in an application system, losses caused by the exception can be greatly reduced if an alarm can be made in time or even in advance. In the conventional art, a monitoring and alarming solution is generally used in an application system to find an exception in time. That is, an alarm message is sent to an alarm object when it is monitored that the application system failed or a system alarm threshold has been reached. The existing monitoring and alarming solution has the following problem: alarm messages will be sent to an alarm object constantly when a system triggers an alarm threshold persistently, which not only causes a waste of resources, but also severely disturbs the alarm object.

### SUMMARY OF THE DISCLOSURE

There is provided an exception monitoring and alarming method. The method comprising: recording alarm information for a to-be-processed alarm item; determining whether the alarm information for the to-be-processed alarm item meets a fatigue condition; controlling the to-be-processed alarm item to enter a fatigue period when the alarm information for the to-be-processed alarm item meets the fatigue condition; and conducting alarm control on the to-be-processed alarm item in the fatigue period to reduce a number of alarms for the to-be-processed alarm item.

In the method, recording the alarm information for a to-be-processed alarm item comprises: recording at least one of the number of alarms for the to-be-processed alarm item or an alarm time for the to-be-processed alarm item.

In the method, determining whether the alarm information for the to-be-processed alarm item meets a fatigue condition comprises performing at least one of the operations: determining whether the number of alarms for the to-be-processed alarm item is greater than a preset number threshold; determining whether the alarm time for the to-be-processed alarm item is within a preset time range; or determining whether the alarm frequency for the to-be-processed alarm item is greater than a frequency threshold, wherein the alarm information for the to-be-processed alarm item meets the fatigue condition if a determining result of at least one of the operations is yes.

In the method, conducting the alarm control on the to-be processed alarm item in the fatigue period comprises: intercepting alarm requests of the to-be-processed alarm item in the fatigue period; and conducting alarm processing on the to-be-processed alarm item based on the principle that the number of alarms is less than a number of alarm requests.

In the method, controlling the to-be-processed alarm item to enter a fatigue period comprises: removing the to-be-processed alarm item from an alarm queue and adding the to-be-processed alarm item into a fatigue period queue, wherein the alarm queue is configured to store alarm items that require alarm processing according to each alarm request, and the fatigue period queue is configured to store alarm items on which alarm processing to be conducted based on the principle that the number of alarms is less than the number of alarm requests.

The method further comprises removing the to-be-processed alarm item from the fatigue period queue and adding the to-be-processed alarm item into the alarm queue when the to-be-processed alarm item meets a preset alarm condition, wherein the preset alarm condition comprises at least one of the conditions: the fatigue period ends; a time interval between two adjacent alarm requests of the to-be-processed alarm item in the fatigue period is greater than a preset time interval threshold; an alarm system is turned off; or an alarm rule is modified.

There is provided an exception monitoring and alarming apparatus. The apparatus comprising: a memory storing a set of instructions; and a processor configured to execute the set of instructions to cause the apparatus to perform: recording alarm information for a to-be-processed alarm item; determining whether the alarm information for the to-be-processed alarm item meets a fatigue condition; controlling the to-be-processed alarm item to enter a fatigue period when the alarm information for the to-be-processed alarm item meets the fatigue condition; and conducting alarm control on the to-be-processed alarm item in the fatigue period to reduce a number of alarms for the to-be-processed alarm item.

There is provided a non-transitory computer readable medium that stores a set of instructions that is executable by at least one processor of a computer system to cause the computer system to perform an exception monitoring and alarming method, the method comprising: recording alarm information for a to-be-processed alarm item; determining whether the alarm information for the to-be-processed alarm item meets a fatigue condition; controlling the to-be-processed alarm item to enter a fatigue period when the alarm information for the to-be-processed alarm item meets the fatigue condition; and conducting alarm control on the to-be-processed alarm item in the fatigue period to reduce a number of alarms for the to-be-processed alarm item.

The above description is merely a brief summary of the technical solutions of the present disclosure. Specific implementations of the present disclosure are described specifically in the following to help those skilled in the art understand the technical means of the present disclosure more clearly and hence implement the present disclosure according to the content of the specification, and to make the above and other objectives, features and advantages of the present disclosure more comprehensible.

### BRIEF DESCRIPTION OF THE DRAWINGS

Those of ordinary skill in the art will be clear about various other advantages and benefits after reading detailed descriptions of the following preferred embodiments. The accompanying drawings are merely used for showing the preferred embodiments, and are not construed as limitations on the present disclosure. In all the accompanying drawings, identical components are represented by identical reference numerals. In the accompanying drawings:

FIG. 1 is a flowchart indicating an exemplary exception monitoring and alarming method, consistent with some embodiments of the present disclosure;

FIG. 2 is a schematic diagram illustrating N fatigue period queues that share the same fatigue period, consistent with some embodiments of the present disclosure;

FIG. 3 is a schematic diagram illustrating N fatigue period queues that use different fatigue periods respectively, consistent with some embodiments of the present disclosure;

FIG. 4 is a schematic diagram illustrating an exemplary alarm processing conducted on a to-be-processed alarm item by using combination of an alarm queue and a fatigue period queue, consistent with some embodiments of the present disclosure; and

FIG. 5 is a schematic diagram illustrating an exemplary exception monitoring and alarming apparatus, consistent with some embodiments of the present disclosure.

### DETAILED DESCRIPTION

Exemplary embodiments of the disclosure are described below in more detail with reference to the accompanying drawings. The exemplary embodiments of the disclosure are shown in the accompanying drawings; however, it should be understood that the disclosure can be implemented in various forms and should not be limited by the embodiments described here. In contrast, the embodiments are provided such that the disclosure can be understood more thoroughly and completely, and the scope of the disclosure can be conveyed to those skilled in the art completely.

The exception monitoring solution in conventional art suffers from disadvantages, for example, alarm messages are sent to an alarm object constantly when a system triggers an alarm threshold persistently, which not only causes a waste of resources, but also severely disturbs the alarm object.

To solve the above problem, the present disclosure provides establishing a fatigue period for an alarm item, which is controlled to enter the fatigue period when the alarm item meets a condition of entering the fatigue period. The and alarm control is conducted for the alarm item in the fatigue period to reduce the number of alarms for the alarm item. As such, on one hand, alarm processing can be performed for the to-be-processed alarm item; on the other hand, the number of alarms for the to-be-processed alarm item can be reduced appropriately, thus saving resources consumed by exception alarms and reducing interferences to an alarm object.

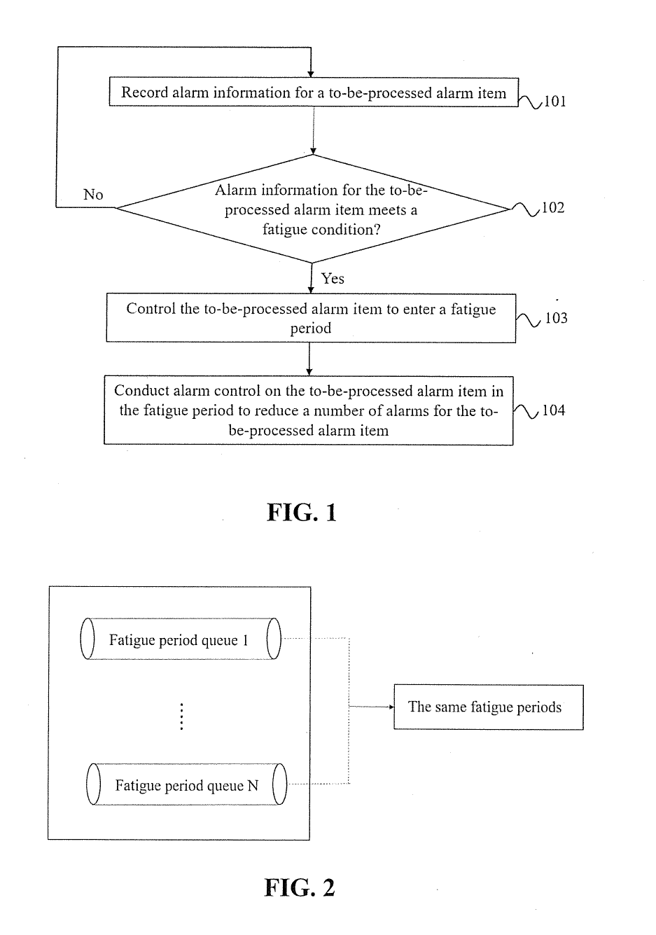

The technical solution of the present disclosure will be described in detail through exemplary embodiments as follows. FIG. 1 is a flowchart indicating an exemplary exception monitoring and alarming method, consistent with some embodiments of the present disclosure. As shown in FIG. 1, the method comprises the following steps:
Step 101: Recording alarm information for a to-be-processed alarm item.
Step 102: Determining whether the alarm information for the to-be-processed alarm item meets a fatigue condition. If the condition is met, step 103 is performed. And if the to-be-processed alarm item does not meet the fatigue condition, the procedure returns to Step 101.
Step 103: Controlling the to-be-processed alarm item to enter a fatigue period.
Step 104: Conducting alarm control on the to-be-processed alarm item in the fatigue period to reduce the number of alarms for the to-be-processed alarm item.

The exemplary method can be performed by an exception monitoring and alarming apparatus, for monitoring an exception in a system and making an alarm appropriately, thus saving resources consumed by exception alarms and reducing interferences to an alarm object.

The exemplary method is applicable to any scenario and system in which exception monitoring is required, for example, a task scheduling system, a crawler system, an electromechanical system, an information collection system, and the like. In some embodiments, an object that to be monitored, e.g., an object that may trigger an alarm, is referred to as an alarm item. The alarm item varies in specific implementations according to different application systems. For example, the alarm item may be a specific to-be-scheduled task for a task scheduling system. For another example, the alarm item may be a running state of a network crawler for a crawler system. For another example, for an electromechanical system, the alarm item may be an operation state of a related device or module in the electromechanical system. To facilitate description and distinction, an alarm item that requires alarm control processing is referred to as a to-be-processed alarm item in some embodiments, and the to-be-processed alarm item can be any alarm item in any application system.

Specifically, in the conventional state, the to-be-processed alarm item can trigger an alarm when meeting a preset alarm condition, e.g., send an alarm request to the exception monitoring and alarming apparatus. The apparatus can conduct alarm processing on the to-be-processed alarm item according to the alarm request of the to-be-processed alarm item. In some embodiments, the alarm processing mainly refers to sending an alarm message to an alarm object (or referred to as an alarm receiver). If the to-be-processed alarm item triggers alarms frequently, the exception monitoring and alarming apparatus would need to send alarm messages to the alarm object frequently. This not only wastes resources, but also causes interferences to the alarm object if the alarms are made at an inappropriate time.

To solve the above problem of convention systems, in some embodiments, a fatigue period is set for the to-be-processed alarm item. In some embodiments, the fatigue period may refer to a time period in which the number of alarms for the to-be-processed alarm item can be reduced. Correspondingly, a fatigue condition is set to determine whether the to-be-processed alarm item can enter the fatigue period. On this basis, in addition to conducting alarm processing on the to-be-processed alarm item according to the alarm request of the to-be-processed alarm item in the normal state, the exception monitoring and alarming apparatus can also record alarm information for the to-be-processed alarm item, and determine whether the to-be-processed alarm item can enter the fatigue period according to the alarm information for the to-be-processed alarm item. Specifically, the exception monitoring and alarming apparatus determines whether the alarm information for the to-be-processed alarm item meets a fatigue condition. If the alarm information for the to-be-processed alarm item meets the fatigue condition, the to-be-processed alarm item is controlled to enter the fatigue period. Moreover, in the fatigue period, alarm control is conducted on the to-be-processed alarm item to reduce the number of alarms for the to-be-processed alarm item.

In some embodiments, the alarm information for the to-be-processed alarm item includes at least one of the number of alarms or the alarm time for the to-be-processed alarm item. The number of alarms for the to-be-processed alarm item may refer to the total number of alarm times for the to-be-processed alarm item in a designated time period, and the designated time period may be recent one week, one day, two days, and the like. The alarm time for the to-be-processed alarm item may refer to a time of each alarm for the to-be-processed alarm item in a designated time period.

Based on at least one of the number of alarms or the alarm time for the to-be-processed alarm item included in the alarm information for the to-be-processed alarm item, the fatigue condition may include at least one of the following:
(a) the number of alarms for the to-be-processed alarm item is greater than a number threshold;
(b) the alarm time for the to-be-processed alarm item is within a preset time range; and
(c) the alarm frequency for the to-be-processed alarm item is greater than a frequency threshold.

Based on the above, the step of determining whether the alarm information for the to-be-processed alarm item meets a fatigue condition includes performing at least one of the following determination operations:
(a) determining whether the number of alarms for the to-be-processed alarm item is greater than the number threshold;
(b) determining whether the alarm time for the to-be-processed alarm item is within the preset time range; and
(c) determining whether the alarm frequency for the to-be-processed alarm item is greater than the frequency threshold.

If the determining result includes at least one of: (a′) the number of alarms for the to-be-processed alarm item is greater than the number threshold; (b′) the alarm time for the to-be-processed alarm item is within the preset time range; or (c′) the alarm frequency for the to-be-processed alarm item is greater than the frequency threshold, it is determined that the alarm information for the to-be-processed alarm item meets the fatigue condition, meaning that the to-be-processed alarm item can enter the fatigue period. Correspondingly, if the determination result includes at least one of: (a″) the number of alarms for the to-be-processed alarm item is not greater than the number threshold; (b″) the alarm time for the to-be-processed alarm item is not within the preset time range; or (c″) the alarm frequency for the to-be-processed alarm item is not greater than the frequency threshold, it is determined that the alarm information for the to-be-processed alarm item does not meet the fatigue condition, meaning that the to-be-processed alarm item cannot enter the fatigue period.

Duration of a real alarm time period can be obtained according to the time of the first alarm for the to-be-processed alarm item and the time of the last alarm for the to-be-processed alarm item in the designated time period. The alarm frequency for the to-be-processed alarm item can be obtained by using the duration of the real alarm time period and the total number of alarms for the to-be-processed alarm item in the designated time period.

In some embodiments, conducting alarm control on the to-be-processed alarm item in the fatigue period to reduce the number of alarms for the to-be-processed alarm item includes: intercepting alarm requests of the to-be-processed alarm item in the fatigue period; and conducting alarm processing on the to-be-processed alarm item based on a principle that the number of alarms is less than the number of alarm requests.

Specifically, in the fatigue period, the exception monitoring and alarming apparatus monitors the to-be-processed alarm item, intercepts alarm requests sent to the apparatus when finding that the to-be-processed alarm item triggers an alarm as it meets the preset alarm condition, and conducts alarm processing on the to-be-processed alarm item based on the principle that the number of alarms is less than the number of alarm requests.

The exception monitoring and alarming apparatus may not conduct alarm processing on the to-be-processed alarm item based on the principle that the number of alarm times is less than the number of alarm requests. For example, in the fatigue period, the exception monitoring and alarming apparatus may conduct alarm processing on the to-be-processed alarm item at intervals of one or several alarm requests. For another example, in the fatigue period, the exception monitoring and alarming apparatus does not conduct alarm processing on the to-be-processed alarm item. For another example, in the fatigue period, the exception monitoring and alarming apparatus may conduct alarm processing on the to-be-processed alarm item only once. For example, the apparatus may conduct alarm processing on the to-be-processed alarm item in response to the first alarm request only, and no longer conducts alarm processing on the to-be-processed alarm item for subsequent alarm requests.

In some embodiments, when the alarm information for the to-be-processed alarm item meets the fatigue condition, an implementation of controlling the to-be-processed alarm item to enter the fatigue period includes: making a fatigue mark for the to-be-processed alarm item; and starting a timer to time the fatigue period. The exception monitoring and alarming apparatus can determine whether an alarm item carries a fatigue mark. Responsive to a determination that an alarm item carries a fatigue mark, the apparatus determines whether an alarm control to be conducted on the alarm item in a fatigue period corresponding to the alarm item to reduce the number of alarms for the to-be-processed alarm item. The fatigue period ends when the timing of the timer ends.

In some embodiments, two storage queues are pre-configured: one is an alarm queue, and the other is a fatigue period queue. The alarm queue is used to store alarm items that require alarm processing according to each alarm request. In other words, for an alarm item in the alarm queue, the exception monitoring and alarming apparatus conducts alarm processing for the alarm item each time an alarm request of the alarm item is received. The fatigue period queue is used to store alarm items on which alarm processing to be conducted based on the principle that the number of alarms is less than the number of alarm requests. In other words, for an alarm item in the fatigue period queue, the exception monitoring and alarming apparatus should not conduct alarm processing for the alarm item each time an alarm request of the alarm item is received, but should reduce the number of alarms for the alarm item as much as possible.

In some embodiments, when the alarm information for the to-be-processed alarm item meets the fatigue condition, an implementation of controlling the to-be-processed alarm item to enter the fatigue period includes: removing the to-be-processed alarm item from the alarm queue; and adding the to-be-processed alarm item into the fatigue period queue.

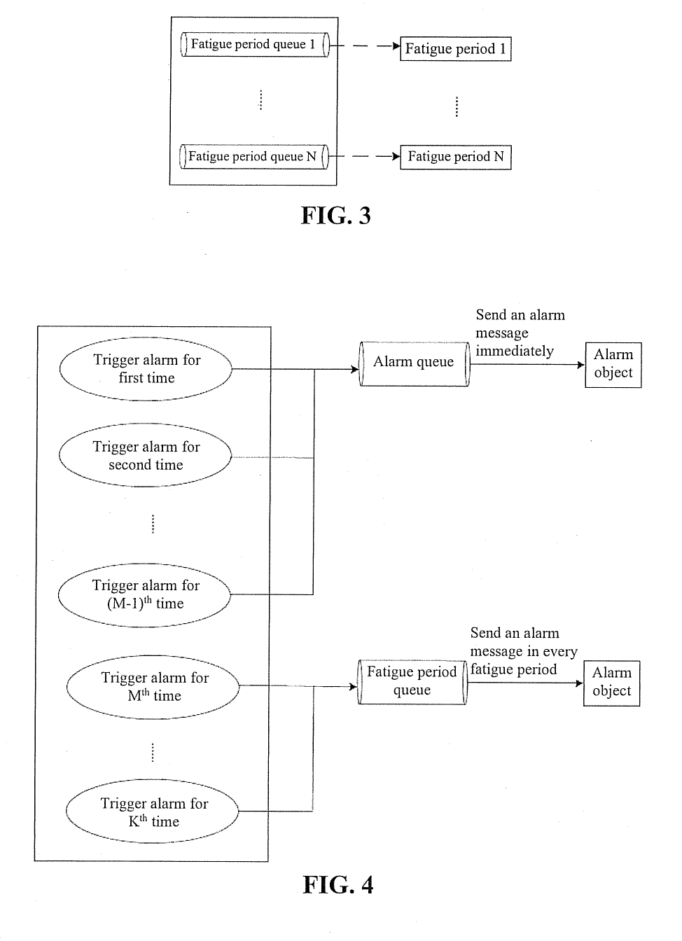

It should be noted that there can be one or more fatigue period queues. If multiple fatigue period queues are used, the fatigue period queues can have the same fatigue period length or different fatigue period lengths. FIG. 2 shows a schematic diagram illustrating N fatigue period queues that share the same fatigue period, consistent with some embodiments of the present disclosure, and FIG. 3 shows a schematic diagram illustrating N fatigue period queues that use different fatigue periods respectively, consistent with some embodiments of the present disclosure. N is a natural number greater than 1.

FIG. 4 is a schematic diagram illustrating an exemplary alarm processing conducted on a to-be-processed alarm item by using combination of an alarm queue and a fatigue period queue, consistent with some embodiments of the present disclosure. The to-be-processed alarm item is located in the alarm queue. In the process from a first trigger to a (M−1)^{th} trigger of an alarm by the to-be-processed alarm item, the exception monitoring and alarming apparatus sends an alarm message for the to-be-processed alarm item to the alarm object each time a trigger of an alarm is monitored. It should be noted that in the process from the first trigger to the (M−1)^{th} trigger of an alarm, time intervals between two adjacent triggers of alarms can be the same or different.

When the to-be-processed alarm item triggers an alarm for the M^{th} time, the exception monitoring and alarming apparatus determines whether the number of alarms for the to-be-processed alarm item is greater than a number threshold, e.g., the condition of entering the fatigue period is met. If the condition of entering the fatigue period is met, the exception monitoring and alarming apparatus removes the to-be-processed alarm item from the alarm queue and adds it to the fatigue period queue and sends an alarm message for the to-be-processed alarm item to the alarm object. Then, even if the to-be-processed alarm item further triggers (K-M) alarms in the fatigue period, the exception monitoring and alarming apparatus no longer sends an alarm message for the to-be-processed alarm item to the alarm object. M and K are both natural numbers, where K>M>1. The present disclosure is not limited to this implementation. Any implementation capable of ensuring that a number of alarms is less than a number of alarm triggering falls within the protection scope of the present disclosure.

In some embodiments, to conduct alarm processing for the to-be-processed alarm item normally, timely and reasonably, the to-be-processed alarm item does not always stay in the fatigue period. On this basis, an alarm condition is preset. When the to-be-processed alarm item meets the preset alarm condition, the to-be-processed alarm item can be removed from the fatigue period queue and added into the alarm queue again.

The foregoing alarm condition can include at least one of the following:
(a) the fatigue period ends, meaning that the to-be-processed alarm item is added to the alarm queue and processed accordingly;
(b) a time interval between two adjacent alarm requests of the to-be-processed alarm item in the fatigue period is greater than a time interval threshold, indicating that the to-be-processed alarm item does not trigger alarms as frequently and is added to the alarm queue;
(c) an alarm system is turned off, meaning that a default state is restored, wherein normal alarm processing is conducted on all alarm items, and thus the to-be-processed alarm item is added to the alarm queue; and
(d) an alarm rule is modified, meaning that a default state is restored, wherein normal alarm processing is conducted on all alarm items by default, and thus the to-be-processed alarm item is added to the alarm queue.

In some embodiments, when the to-be-processed alarm item meets the condition of entering the fatigue period, the to-be-processed alarm item can be added to the fatigue period queue from the alarm queue, thus implementing circular processing. In this case, alarm processing can be conducted on a to-be-processed alarm item normally in a non-fatigue period, and the number of alarms for the to-be-processed alarm item can be reduced in a fatigue period. By this way, on one hand, alarming an exception can be conducted for the to-be-processed alarm item, and on the other hand, the number of alarms for the to-be-processed alarm item can be reduced, thus saving resources consumed by alarming and reducing interferences to an alarm object.

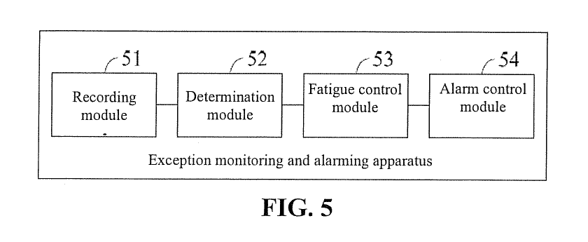

FIG. 5 is a schematic diagram illustrating an exemplary exception monitoring and alarming apparatus, consistent with some embodiments of the present disclosure. As shown in FIG. 5, the apparatus comprises a recording module 51, a determination module 52, a fatigue control module 53, and an alarm control module 54. Recording module 51 is configured to record alarm information for a to-be-processed alarm item. Determination module 52 is configured to determine whether the alarm information for the to-be-processed alarm item meets a fatigue condition. Fatigue control module 53 is configured to control the to-be-processed alarm item to enter a fatigue period when the determination result of determination module 52 is yes. Alarm control module 54 is configured to conduct alarm control on the to-be-processed alarm item in the fatigue period to reduce the number of alarms for the to-be-processed alarm item.

In some embodiments, recording module 51 is configured to record at least one of a number of alarms or an alarm time for the to-be-processed alarm item. The number of alarms for the to-be-processed alarm item may refer to the total number of alarms for the to-be-processed alarm item in a designated time period, wherein the designated time period may be recent one week, one day, two days, and the like. The alarm time for the to-be-processed alarm item may refer to time of each alarm for the to-be-processed alarm item in a designated time period.

Based on the number of alarms or the alarm time for the to-be-processed alarm item included in the alarm information for the to-be-processed alarm item, the fatigue condition may comprise at least one of the followings:
(a) a number of alarms for the to-be-processed alarm item is greater than a number threshold;
(b) an alarm time for the to-be-processed alarm item is within a preset time range; or
(c) an alarm frequency for the to-be-processed alarm item is greater than a frequency threshold.

Corresponding, determination module 52 is configured to perform at least one of the following determination operations:
(a) determining whether the number of alarms for the to-be-processed alarm item is greater than the number threshold;
(b) determining whether the alarm time for the to-be-processed alarm item is within the preset time range; or
(c) determining whether the alarm frequency for the to-be-processed alarm item is greater than the frequency threshold.

If the determination result of the at least one determination operation is yes, it is determined that the alarm information for the to-be-processed alarm item meets the fatigue condition.

Duration of a real alarm time period can be obtained according to the time of the first alarm for the to-be-processed alarm item and the time of the last alarm for the to-be-processed alarm item in the designated time period. The alarm frequency for the to-be-processed alarm item can be obtained by using the duration of the real alarm time period and the total number of alarms for the to-be-processed alarm item in the designated time period.

In some embodiments, alarm control module 54 is configured to: intercept alarm requests of the to-be-processed alarm item in the fatigue period; and conduct alarm processing on the to-be-processed alarm item based on the principle that the number of alarms is less than the number of alarm requests.

In some embodiments, fatigue control module 53 is configured to: remove the to-be-processed alarm item from an alarm queue; and add the to-be-processed alarm item into a fatigue period queue. The alarm queue is used to store alarm items that require alarm processing according to each alarm request. The fatigue period queue is used to store alarm items on which alarm processing to be conducted based on the principle that the number of alarm times is less than the number of alarm requests.

In some embodiments, fatigue control module 53 is also configured to: remove the to-be-processed alarm item from the fatigue period queue; and add the to-be-processed alarm item into the alarm queue again when the to-be-processed alarm item meets a preset alarm condition. The preset alarm condition can include at least one of the followings:
(a) the fatigue period ends, meaning that the to-be-processed alarm item requires normal alarm processing again and thus is added to the alarm queue again;
(b) a time interval between two adjacent alarm requests of the to-be-processed alarm item in the fatigue period is greater than a preset time interval threshold, indicating that the to-be-processed alarm item does not trigger alarms frequently anymore and thus is added to the alarm queue again;
(c) the alarm system is turned off, meaning that a default state is restored, wherein normal alarm processing is conducted on all alarm items by default, and thus the to-be-processed alarm item is added to the alarm queue again; or
(d) the alarm rule is modified, meaning that a default state is restored, wherein normal alarm processing is conducted on all alarm items by default, and thus the to-be-processed alarm item is added to the alarm queue again.

In some embodiments, fatigue control module 53 is also configured to add, when the to-be-processed alarm item meets the condition of entering the fatigue period again, the to-be-processed alarm item to the fatigue period queue again from the alarm queue, thus implementing circular processing.

In some embodiments, in an exception monitoring and alarming apparatus, an alarm processing can be conducted on a to-be-processed alarm item normally in a non-fatigue period, and a number of alarms for the to-be-processed alarm item can be reduced in a fatigue period. By this way, on one hand, the alarming can be conducted for the to-be-processed alarm item, and on the other hand, the number of alarms for the to-be-processed alarm item can be reduced, thus saving resources consumed by the alarming and reducing interferences to an alarm object.

It can be appreciated that all or part of steps of the exemplary methods of the present disclosure can be completed by a program instructing related hardware. The program can be stored in a computer readable storage medium. When being executed, the program performs steps of the exemplary methods. The storage medium includes various media that can store program codes, such as a ROM, a RAM, a magnetic disk, or an optical disc.

Finally, it should be noted that the above embodiments are merely used for describing the technical solutions of the present disclosure, instead of limiting the present disclosure. Although the present disclosure is described in detail with reference to the foregoing embodiments, those of ordinary skill in the art should understand that they can still make modifications on the technical solutions recorded in the above embodiments or perform equivalent replacements on all or a part of technical features of the above embodiments. These modifications or replacements do not cause the essences of the corresponding technical solutions to depart from the scope of the technical solutions of the embodiments of the present disclosure.

What is claimed is:

1. An exception monitoring and alarming method, comprising:
recording alarm information for a to-be-processed alarm item;
determining whether the alarm information meets a fatigue condition;
controlling the to-be-processed alarm item to enter a fatigue period in response to the alarm information meeting the fatigue condition; and
conducting an alarm control on the to-be-processed alarm item in the fatigue period.

2. The method according to claim 1, wherein:
recording the alarm information for the to-be-processed alarm item comprises:
recording at least one of the number of alarms for the to-be-processed alarm item or an alarm time for the to-be-processed alarm item; and
determining whether the alarm information meets the fatigue condition comprises determining that the alarm condition meets the fatigue condition in response to at least one of the conditions being satisfied:
a number of alarms for the to-be-processed alarm item is greater than a number threshold;
alarm time for the to-be-processed alarm item is within a preset time range; or
an alarm frequency for the to-be-processed alarm item is greater than a frequency threshold.

3. The method according to claim 1, wherein conducting the alarm control on the to-be processed alarm item in the fatigue period comprises:
intercepting alarm requests of the to-be-processed alarm item in the fatigue period; and
conducting an alarm processing on the to-be-processed alarm item based on that a number of alarms is less than a number of alarm requests.

4. The method according to claim 1, wherein controlling the to-be-processed alarm item to enter the fatigue period comprises:
removing the to-be-processed alarm item from an alarm queue and adding the to-be-processed alarm item into a fatigue period queue,
wherein the alarm queue is configured to store alarm items that require alarm processing according to each alarm request, and the fatigue period queue is configured to store alarm items on which an alarm processing is conducted based on that a number of alarms is less than the number of alarm requests.

5. The method according to claim 4, further comprising:
removing the to-be-processed alarm item from the fatigue period queue and adding the to-be-processed alarm item into the alarm queue when the to-be-processed alarm item meets an alarm condition.

6. The method according to claim 5, wherein the preset alarm condition comprises at least one of the conditions:
the fatigue period ends;
a time interval between two adjacent alarm requests of the to-be-processed alarm item in the fatigue period is greater than a time interval threshold;
an alarm system is turned off; or
an alarm rule is modified.

7. An exception monitoring and alarming apparatus, the apparatus comprising:
a memory storing a set of instructions; and
a processor configured to execute the set of instructions to cause the apparatus to perform:
recording alarm information for a to-be-processed alarm item;
determining whether the alarm information for the to-be-processed alarm item meets a fatigue condition;
controlling the to-be-processed alarm item to enter a fatigue period when the alarm information for the to-be-processed alarm item meets the fatigue condition; and
conducting an alarm control on the to-be-processed alarm item in the fatigue period to reduce a number of alarms for the to-be-processed alarm item.

8. The apparatus according to claim 7, wherein the processor further executes the set of instructions to cause the apparatus to perform:
recording at least one of the number of alarms or an alarm time for the to-be-processed alarm item, and
wherein determining whether the alarm information for the to-be-processed alarm item meets the fatigue condition comprises at least one of the operations:
determining whether the number of alarms for the to-be-processed alarm item is greater than a number threshold;
determining whether the alarm time for the to-be-processed alarm item is within a preset time range; or
determining whether the alarm frequency for the to-be-processed alarm item is greater than a frequency threshold,
wherein the alarm information for the to-be-processed alarm item meets the fatigue condition if a result of the at least one of the operations is yes.

9. The apparatus according to claim 7, wherein conducting the alarm control on the to-be-processed alarm item in the fatigue period comprises:
intercepting alarm requests of the to-be-processed alarm item in the fatigue period; and
conducting an alarm processing on the to-be-processed alarm item based on that the number of alarms is less than the number of alarm requests.

10. The apparatus according to any of claim 7, wherein controlling the to-be-processed alarm item to enter the fatigue period comprises:
removing the to-be-processed alarm item from an alarm queue and add the to-be-processed alarm item into a fatigue period queue,
wherein the alarm queue is configured to store alarm items that require alarm processing according to each alarm request, and the fatigue period queue is configured to store alarm items on which an alarm processing is conducted based on that the number of alarms is less than the number of alarm requests.

11. The apparatus according to claim 10, the processor further executes the set of instructions to cause the apparatus to perform:
removing the to-be-processed alarm item from the fatigue period queue and add the to-be-processed alarm item into the alarm queue when the to-be-processed alarm item meets an alarm condition.

12. The apparatus according to claim 11, wherein the preset alarm condition comprises at least one of the conditions:
the fatigue period ends;
a time interval between two adjacent alarm requests of the to-be-processed alarm item in the fatigue period is greater than a time interval threshold;
an alarm system is turned off; or
an alarm rule is modified.

13. A non-transitory computer readable medium that stores a set of instructions that is executable by at least one processor of a computer system to cause the computer system to perform an exception monitoring and alarming method, the method comprising:
recording alarm information for a to-be-processed alarm item;
determining whether the alarm information for the to-be-processed alarm item meets a fatigue condition;
controlling the to-be-processed alarm item to enter a fatigue period when the alarm information for the to-be-processed alarm item meets the fatigue condition; and
conducting alarm control on the to-be-processed alarm item in the fatigue period to reduce a number of alarms for the to-be-processed alarm item.

14. The non-transitory computer readable medium according to claim 13, wherein:
recording the alarm information for the to-be-processed alarm item comprises:
recording at least one of the number of alarms for the to-be-processed alarm item or an alarm time for the to-be-processed alarm item, and
determining whether the alarm information for the to-be-processed alarm item meets a fatigue condition comprises performing at least one of the operations:
determining whether the number of alarms for the to-be-processed alarm item is greater than a number threshold;
determining whether the alarm time for the to-be-processed alarm item is within a preset time range; or
determining whether the alarm frequency for the to-be-processed alarm item is greater than a frequency threshold,
wherein the alarm information for the to-be-processed alarm item meets the fatigue condition if a determining result of at least one of the operations is yes.

15. The non-transitory computer readable medium according to claim 13, wherein conducting the alarm control on the to-be processed alarm item in the fatigue period comprises:
intercepting alarm requests of the to-be-processed alarm item in the fatigue period; and
conducting an alarm processing on the to-be-processed alarm item based on that the number of alarms is less than a number of alarm requests.

16. The non-transitory computer readable medium according to claim 13, wherein controlling the to-be-processed alarm item to enter a fatigue period comprises:
removing the to-be-processed alarm item from an alarm queue and adding the to-be-processed alarm item into a fatigue period queue,
wherein the alarm queue is configured to store alarm items that require alarm processing according to each alarm request, and the fatigue period queue is configured to store alarm items on which alarm processing is conducted based on that the number of alarms is less than the number of alarm requests.

17. The non-transitory computer readable medium according to claim 16, further comprising:
removing the to-be-processed alarm item from the fatigue period queue and adding the to-be-processed alarm item into the alarm queue when the to-be-processed alarm item meets an alarm condition.

18. The non-transitory computer readable medium according to claim 17, wherein the preset alarm condition comprises at least one of the conditions:
the fatigue period ends;
a time interval between two adjacent alarm requests of the to-be-processed alarm item in the fatigue period is greater than a time interval threshold;
an alarm system is turned off; or
an alarm rule is modified.
